(19) United States
(12) Patent Application Publication
(10) Pub. No.: US 2008/0118611 A1
(43) Pub. Date: May 22, 2008

(54) Pocket-Size Packet of Confectionery Products

(76) Inventors: Cesare Cellie, Casalecchio Di Reno (IT); Andrea Zecchini, Bologna (IT)

Correspondence Address: Harbin King & Klima, 500 Ninth Street, SE, Washington, DC, 20003, US

(21) Appl. No.: 11/795,241

(22) PCT Filed: Jan. 12, 2006
(86) PCT No.: PCT/IB06/00039

§ 371 Date: Jul. 13, 2007

(30) Foreign Application Priority Data
Jan. 14, 2005 (IT) BO2005A000018

(51) Int. Cl. B65D 77/02; B65D 85/60; A23G 3/34

(52) U.S. Cl. 426/108; 426/106

(57) ABSTRACT

Confectionery products (2) of identical shape and size are ordered one on top of the other in a single stack (3) aligned on a predominating longitudinal axis (X), in the manner of a conventional stick-pack, and presented in a rigid packet (1) identifiable as a container (4) accommodating the stacked products (2) in a close fit and furnished with a hinged lid (9) flippable between positions in which the container is open and closed.

### TECHNICAL FIELD

The present invention relates to a pocket-size packet of confectionery products.

### BACKGROUND ART

A stick pack of confectionery products typical of the prior art, for example containing sweets, candy, caramels, etc., will generally contain a plurality of single confectionery pieces placed one on top of another so as to form a single stack. The stack is enveloped in a pliable wrapper, consisting usually in one or more layers of food-safe sheet material.

Removing at least a part of the wrapper initially, a consumer can free the topmost confectionery piece of the stack, whereupon more of the wrapper can be discarded progressively to release further pieces.

The prior art also embraces stick packs with a tear-off seal ribbon passing transversely around the wrapper in a complete loop, which must be removed in order to release the contents of the pack.

In particular, the tear-off ribbon is located near to one end of the wrapper. Removing the ribbon, the wrapper is divided into a first part containing the confectionery products, and a second part that will be discarded. The contents of the pack are thus released and the consumer can take out one or more of the pieces.

In reality, the confectionery products contained in such a pack are not usually consumed all at once, and when one or more pieces have been separated from the rest, the wrapper will be folded partly over the open end to prevent the remaining pieces from dropping out accidentally.

Stick packs of confectionery products identifiable with the prior art present the drawback of being unable to guarantee an acceptable level of hygiene in respect of the products they contain.

In effect, stick packs are carried typically in the pocket of a garment, or in a handbag or the like, so as to be handy at any given moment.

It can easily happen, in this situation, that a stick pack of prior art type will break or reopen accidentally and cause the contents to scatter, with the result that the single pieces of confectionery become contaminated and consequently are no longer fit for consumption.

When kept in a pocket, bag or pouch, moreover, a stick pack of prior art type that has been opened, with the wrapper then folded down in part to retain the remainder of the contents, will almost inevitably reopen of its own accord.

Accordingly, the principal object of the present invention is to provide a pocket-size packet of confectionery products unaffected by the drawbacks mentioned above.

One object of the present invention, in particular, is to provide a packet that will ensure a good standard of hygiene in respect of the products it contains.

A further object of the invention is to set forth a pocket-size packet of confectionery products that will not reopen accidentally and cause the contents to scatter, even when a part of the selfsame contents may already have been removed from the packet.

### DISCLOSURE OF THE INVENTION

The aforestated objects are substantially realized, according to the invention, in a pocket-size packet of confectionery products as characterized in one or more of the claims appended.

The invention will now be described in detail, by way of example, with the aid of the accompanying drawings, in which.

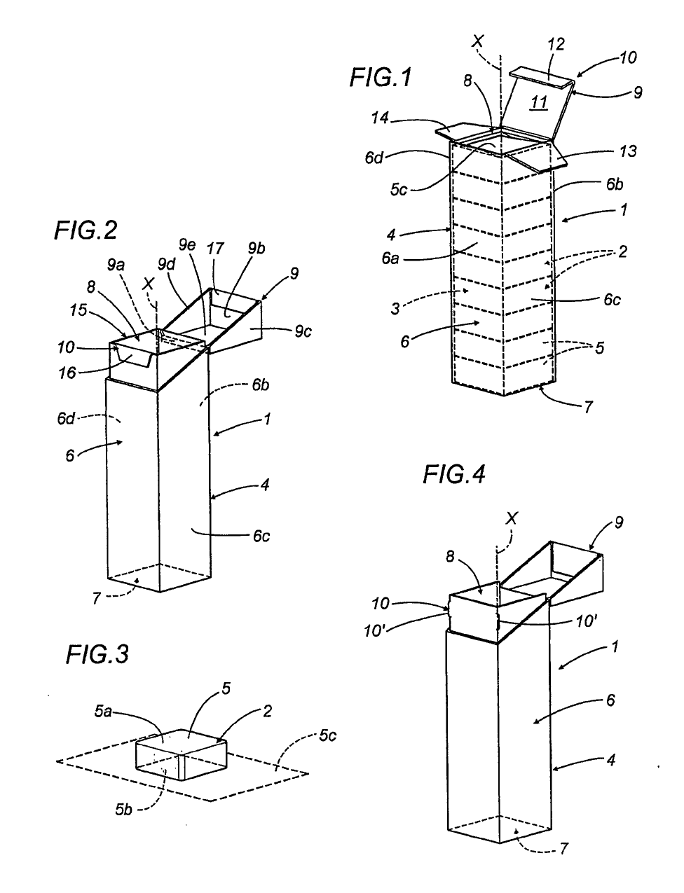

FIG. 1 is a perspective view showing a pocket-size packet of confectionery products in accordance with the present invention;

FIG. 2 and FIGS. 4 to 8 are perspective views showing variations on the packet of confectionery products illustrated in FIG. 1;

FIG. 3 shows a detail of the product contained in the packets of FIGS. 1 and 2.

With reference to the figures of the accompanying drawings, numeral 1 denotes a pocket-size packet of confectionery products, in its entirety, embodied according to the present invention.

The packet 1 is designed to contain a plurality of confectionery products 2, appearing as single pieces of identical shape and size placed one on top of another to form a stack 3 (see FIG. 1) aligned on a predominating longitudinal axis denoted X. To this end, the packet 1 comprises a containing body 4 matched to the shape of the stack 3 and accommodating the products 2.

In the examples of the accompanying drawings, the confectionery products are illustrated as caramels 5, albeit no limitation in scope is thus implied. More exactly, and as illustrated in FIG. 3, the single caramel 5 appears as a right prism with polygonal bases 5a and 5b. The caramels 5 are stacked with the respective bases 5a and 5b offered in contact one to the next. To ensure an acceptable level of hygienic integrity, moreover, even after their removal from the packet 1, each of the caramels 5 is protected by an individual wrapper 5c.

To advantage, the containing body 4 is rigid and holds its shape even when empty, so that the pressure exerted by a consumer when handling the packet can be absorbed to reasonably good effect, and without the packet itself undergoing plastic deformation.

In particular, the rigid containing body 4 appears as a right prism presenting a lateral surface 6 that surrounds the stack 3 of confectionery products 2 and is joined to a base 7 at the bottom end. The packet 1 presents an opening 8 at one end of the containing body 4, and more exactly at the end opposite from the bottom end base 7, affording access to the inside of the body 4 and therefore to its contents. The bottom end base 7 and the opening 8 are substantially identical in shape and size to a cross section taken through the stack 3 of products 2 on a plane normal to the aforementioned predominating axis X.

Advantageously, the packet 1 comprises a closure element consisting in a lid 9 attached hingedly to the containing body 4 and rotatable thus between a position in which the packet 1 is open and a position in which the packet 1 is closed. The lid 9 is hinged to the containing body 4 at a point coinciding with the opening 8, and held in the closed position by retaining means denoted 10.

In the examples of FIGS. 1 and 2, the lateral surface 6 of the containing body 4 comprises a front wall 6a, a rear wall 6b and two flank walls 6c and 6d. Since the confectionery products 2 in these two embodiments are caramels 5 of square outline, the bottom end base 7 and the opening 8 of the containing body 4 likewise present a square outline, so that the body 4 appears as a right prism with square bases. As already intimated, however, the shape of the base 7 and the opening 8 will be matched to and therefore determined by the outline of the single confectionery product 2.

In a first embodiment of the packet, illustrated in FIG. 1, the lid 9 comprises a panel denoted 11, and the retaining means 10 take the form of a tongue 12 associated peripherally with the panel 11 in such a way that the lid 9 can be held displaceably against the containing body 4.

More exactly, the panel 11 is hinged to the body 4 by way of the rear wall 6b. The tongue 12 in turn is hinged to the panel 11 along the side farthest from the rear wall 6b and, with the lid 9 in the closed position, offered to the inside face of the front wall 6a, so that the lid 9 is retained in this same position by the containing body 4.

Gripping the lid 9 and tilting it away from the opening 8, the tongue 12 separates from the body 4 and the packet 1 is laid open. The packet 1 is closed by effecting the same step in reverse.

To ensure a more effective closure of the packet 1, in other words to retain the caramels more securely within the containing body 4, the body itself affords two flaps 13 and 14 hingedly attached to the flank walls 6c and 6d on either side of the opening 8. When closing the packet 1, before lowering the lid 9, the two flaps 13 and 14 are folded inwards across the opening 8 and into partial overlapping contact one with another, so as to supplement the action of the lid 9 in retaining the contents.

In a second embodiment, illustrated in FIG. 2, the lid 9 appears as a box-like, cupped body. In this instance, the retaining means 10 include a frame 15 anchored stably to the containing body 4, at least in part. The frame 15 projects beyond the opening 8, at least in part, and engages the lid 9 when in the closed position.

To maximize the retaining action by which the lid 9 is held to the frame 15, the frame is anchored internally of the containing body 4 to the inside face of the lateral wall 6, and presents at least one tongue 16 associated with the portion projecting beyond the opening 8. The tongue 16 is elastically deformable and bent double toward the body 4 in such a way as to engage an undercut 17 afforded by an inside portion of the box-like lid 9, when the lid is closed, and retain it thus in the closed position.

More exactly, the box-like lid 9 comprises a front wall 9a, a rear wall 9b, two flank walls 9c and 9d and a top 9e. The lid 9 is hinged by way of the rear wall 9b to the rear wall 6b of the containing body 4.

The undercut 17 is created internally of the lid 9, extending along the inside face of the front wall 9a near to the free edge.

In use, the tongue 16 is released from its position of engagement with the undercut 17 when the lid 9 is rotated toward the open position, by reason of the fact that the tongue 16 is elastically deformable, as aforementioned, and will follow the opening movement of the lid 9 only through a distance sufficient to cause its separation from the undercut 17.

When this occurs, the tongue 16 springs back to its original position, bent toward the containing body 4, in readiness to re-engage the lid 9.

In the example of FIG. 4, the frame 15 presents a front wall joined along two corner edges to two flank walls, and is furnished with two punched cuts, each coinciding with a relative corner edge. The two cuts create two fixed tongues 10′ proportioned to engage by interference with the inside faces of the flank walls 9c and 9d of the lid 9 when the lid is closed.

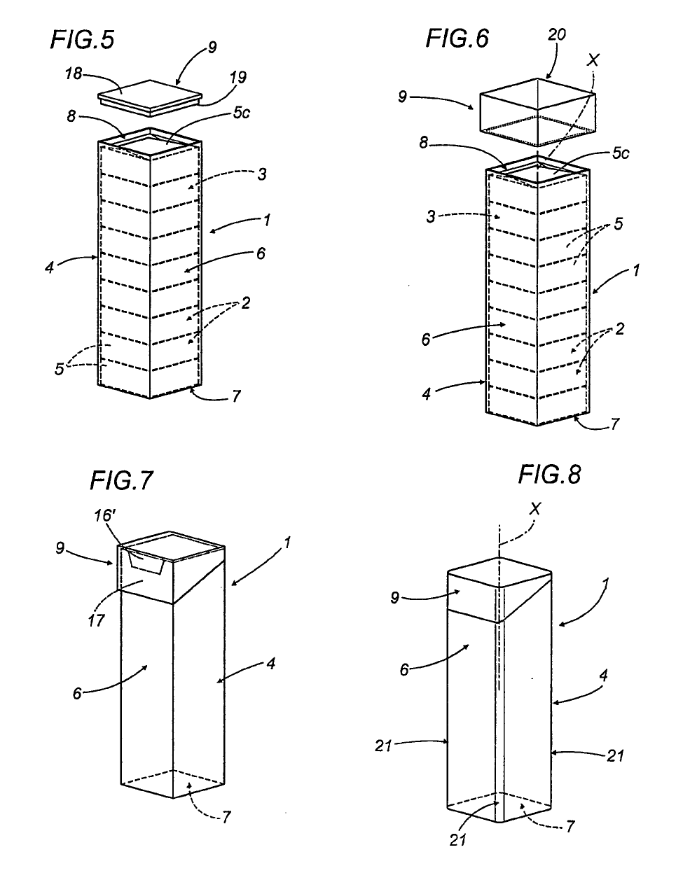

In the example of FIG. 5, the closure element consists in a cap 18 attachable to the opening 8 of the containing body 4. The cap 18 presents a lower portion 19 of transverse dimensions such that it can be inserted forcibly into the opening 8 to obtain a fit in which the selfsame cap remains stably attached to the containing body 4, its outer edges abutting against the edges of the opening 8.

A further embodiment, illustrated in FIG. 6, has a lid 9 in the form of a cap 20 that can be fitted over the opening 8, externally of the body 4.

In the example of FIG. 7, the hinged lid 9 is of internal dimensions such that it can be fitted over the opening 8, externally of the containing body 4. In this instance it is the body 4 that presents an elastically deformable tongue 161 associated with the opening 8 and bent down toward the bottom end, whilst the box-like lid 9 again presents an undercut 17 positioned to interact with the tongue 16′ in such a way that the lid 9 will be retained in the closed position, fitted over the opening 8 externally of the body 4.

Referring to the example of FIG. 8, finally, the longitudinal corner edges of the packet 1, presented both by the containing body 4 and by the lid 9, are rounded or bevelled corner edges 21. This brings the advantages of saving on the amount of paper material utilized to make the packet 1, and obtaining greater stability of the product 5 internally of the selfsame packet, especially when fashioned with rounded or bevelled corner edges as illustrated in FIG. 3, as well as reducing the wear and tear that can be caused to the pockets of a garment by sharp corner edges.

In the preferred embodiments illustrated, the containing body 4 and the lid 9, and the frame 15 when included, are fashioned from a paper material procured in the form of diecut blanks, which can be one or more in number and either flat or prefolded and glued (not illustrated).

The objects stated at the outset are achieved by the present invention.

Being rigid, in effect, the containing body will not break or tear accidentally, even when kept in the pocket of a garment, so that there is no risk of the confectionery products spilling or scattering and being rendered unfit for consumption.

Furthermore, the lid allows an opened packet to be closed again stably, thereby ensuring the hygienic integrity of the confectionery products as mentioned previously.

In a further embodiment of the present invention, not illustrated, the lid could be connected to the containing body by a portion of material such as can be broken apart at the moment when the packet is first opened, and thus serve as a seal guaranteeing the integrity of the packet.

1. A pocket-size packet of confectionery products comprising a plurality of individual confectionery products (2) arranged one on top of another to form a stack (3) aligned on a predominating axis (X), characterized in that it comprises a rigid containing body (4) accommodating the stack of confectionery products, and a closure element associated with the containing body.

2. A packet as in claim 1, wherein the closure element comprises a lid (9) hinged to the containing body (4) and rotatable thus between a position in which the packet is open and a position in which the packet is closed.

3. A packet as in claim 2, wherein the lid (9) is hinged to the containing body (4) alongside an opening (8) located at one end of the selfsame body.

4. A packet as in claim 2, comprising retaining means (10) by which the lid (9) is held in the closed position.

5. A packet as in claim 4, wherein the lid (9) comprises a panel (11), and retaining means (10) comprise a tongue (12) associated peripherally with the panel (11), by which the lid (9) is held displaceably against the containing body (4).

6. A packet as in claim 3, wherein the lid (9) presents a box-like body of cupped appearance.

7. A packet as in claim 4, wherein retaining means (10) comprise a frame (15) anchored at least in part to the containing body (4), projecting beyond the opening (8) of the containing body (4) at least in part, and engaging the lid (9) when in the closed position.

8. A packet as in claim 7, wherein the frame (15) is anchored internally to the containing body (4) and furnished with at least one elastically deformable tongue (16) associated with the portion projecting from the opening (8) of the containing body (4) and bent toward the containing body (4) in such a way as to engage at least one undercut (17) presented by an internal portion of the box-like lid (9) and thus retain the lid in the closed position.

9. A packet as in claim 7, wherein the frame (15) is anchored internally to the containing body (4) and furnished with at least one pair of interference elements presented by the portion projecting from the opening (8) of the containing body (4) and coinciding with the longitudinal corner edges of the frame (15).

10. A packet as in claim 6, wherein the containing body (4) presents at least one elastically deformable tongue (16′) located alongside the opening (8) and bent toward the bottom of the selfsame body in such a way as to engage at least one undercut (17) presented by an internal portion of the box-like lid (9) and thus retain the lid in the closed position externally of the body (4).

11. A packet as in claim 1, wherein the containing body (4) is fashioned entirely of a paper material.

12. A packet as in claim 3, wherein the lid (9) is fashioned of a paper material.

13. A packet as in claim 7, wherein the frame (15) is fashioned of a paper material.

14. A packet as in claim 1, wherein the containing body (4) appears as a right prism with a square base.

15. A packet as in claim 1, wherein the confectionery products (2) are individual sweets or candies, typically caramels (5).

16. A packet as in claim 14, wherein the caramels (5) appear substantially as right prisms with respective polygonal bases (5a, 5b) and are stacked with the respective bases (5a, 5b) offered in contact one to the next.

17. A packet as in claim 1, wherein each single confectionery product (2) of the plurality of confectionery products is enveloped in an individual wrapper (5c).

18. A packet as in claim 1, wherein the closure element consists in a cap (18) attachable to the opening (8) of the container body (4).

19. A packet as in claim 18, wherein the cap (18) comprises a portion (19) insertable forcibly into the opening (8) of the container body (4), and an element abuttable against the edges of the opening.

20. A packet as in claim 18, wherein the closure element consists in a cap (20) attachable to the opening (8) externally of the containing body (4).

21. A packet as in claim 1, wherein the longitudinal corner edges are rounded or bevelled corner edges (21).
